(19) United States
(12) Patent Application Publication
(10) Pub. No.: US 2006/0181042 A1
(43) Pub. Date: Aug. 17, 2006

(54) Animal-powered vehicle

(76) Inventor: Vernon L. Sawyer III, Fairbanks, AK (US)

Correspondence Address: WOOD, NGO & EISENBERG, PLLC, 2121 Eisenhower Ave, Suite 200, Alexandria, VA, 22314, US

(21) Appl. No.: 11/056,359

(22) Filed: Feb. 14, 2005

(51) Int. Cl. B62C 1/02

(52) U.S. Cl. 280/63

(57) ABSTRACT

The present invention is directed to an animal-powered vehicle. In one embodiment the vehicle includes a handle bar, first and second substantially vertically aligned wheel holders, first and second wheels, first and second elongated, platform support pillars, a platform, a substantially rigid, elongated steering stem, and a brake system. The vehicle also includes a means for supporting the platform, and an optional means for load-balance steering. The wheel holders are respectively attached proximate to the ends of the handle bar. The top ends of the platform support pillars are respectively attached proximate to the ends of the handle bar such that the platform support pillars respectively extend downward proximate to and inside the wheel holders. The steering stem extends forward with respect to the middle portion of the handle bar. The brake system is optionally configured to provide skid-steer steering capability.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention relates generally to carts, sleds, vehicles, and apparatuses powered by animals. More specifically, the present invention is directed to a dog chariot powered by one or more dogs and can be used conventionally to transport at least one human operator, or as a sport or recreational vehicle.

### BACKGROUND OF THE INVENTION

There are many known carts, sleds, vehicles, and transportation apparatuses powered by humans and/or animals that are used to transport humans and/or cargo, or to provide exercise and/or recreation for humans and/or animals. There is a need for a generally inexpensive, lightweight, and non-polluting animal-powered vehicles that can provide exercise and/or recreation for the human operator and/or for the animal or animals that power the vehicle.

The animal-powered vehicle of the present invention can be used to provide exercise and/or recreation for an operator of the vehicle and/or for at least one animal, such as, but not limited to, dogs, that power the vehicle. For example, the vehicle of the present invention may be used to help train sled dogs for winter dog sledding events. Dog mushers may be interested in the present invention as well. As another example, the vehicle of the present invention may be used for other sporting events, such as chariot racing. Furthermore, the vehicle of the present invention may be used to transport humans and/or cargo.

The related art of interest describes various carts, sleds, vehicles, and transportation apparatuses powered by humans and/or animals that are used to transport humans and/or cargo, or to provide exercise and/or recreation for humans and/or animals, but none discloses the present invention.

U.S. Patent Application Publication No. US 2004/0075226 A1, published to Kortuem, describes a dog powered and human controlled vehicle comprising a frame structure having a horizontally oriented opening within which will be positioned at least one dog. The frame structure comprises a pair of frame members transversely spaced apart by forward and rearward transversely extending means. The front of the frame is supported by means, which includes a steerable member adapted to have contact with the ground. The rear end of the frame is supported by means adapted to have contact with the ground; the frame structure being thus supported a preselected distance from the ground. Manually operable steering means are provided at the rear end of the structure and are connected to a steerable member at the front end so as to change direction of travel of the vehicle. Means are provided for tethering a dog to the frame structure and for connecting a dog harness on a dog to the frame structure so that forward directed longitudinal pulling force produced by the dog is applied to the frame structure. The vehicle may be steered to rotate about a vertical axis by manual actuation of the steering means at the rear end of the vehicle to operate the steerable member at the front end of the vehicle.

U.S. Pat. No. 4,861,052, issued to Hediger, describes a four-wheeled cart that is provided for the training of sled dogs. The cart is comprised of a chassis having paired steerable front wheels and paired rear wheels mounted upon a stationary axle. A body is removably disposed upon the chassis. A platform disposed rearwardly of the chassis is provided for the operator to stand upon. Steering and braking controls are conveniently located with respect to the platform.

U.S. Pat. No. 5,205,570, issued to Brown, describes a platform member formed of a plurality of elongate slats in contiguous communication relative to one another includes a forward, rear, and medial support bar that are mounted to a respective forward brush bow, forward right and left support legs, and a handle construction respectively. The organization includes a plurality of junctions, each junction including a discrete and unique connector structure to effect ease of assembly and securement of the components of the organization in an integral assemblage.

U.S. Pat. No. 5,433,458, issued to Kampe, describes a dog sled that has improved steering capabilities, and includes spaced-apart sideframes and a plurality of rigid cross ties that hold the sideframes spaced apart in parallel relationship, the cross ties connecting to the side frames by flexible joints, and a flexible bumper or brush bow interconnects front ends of the sideframes. A runner is secured to each sideframe, the front end of the runner connects to the front of the sideframe and a central part of the runner connects to the lower end of the sideframe, providing the runner with a long, rearwardly extending portions. A handle extends transversely from the upper part of one sideframe to the upper part of the other sideframe, and each opposite end of the handle pivotally connects to the sideframe for rotation about an axis in the vertical plane of the sideframe and inclined at a substantial angle between the horizontal and the vertical. Lateral movement of the handle, to one side or the other, will tilt the sideframes and attached runners, and simultaneously one runner will be staggered longitudinally ahead of the other in a manner appropriate for turning the sled.

Furthermore, the website entitled, “Black Ice Dog Sledding Equipment—Superior Wheeled Rig”, which discloses a three-wheeled dog-pulled chariot for operating in the standing position having adjustable locking brakes for stopping and a steering bar for steering dogs in a certain direction. The chariot is light enough to be pulled by one dog.

Foreign patents or patent publications known to the inventor in the field of carts, sleds, vehicles, and transportation apparatuses powered by humans and/or animals that are used to transport humans and/or cargo, or to provide exercise and/or recreation for humans and/or animals, are: FR 2652 792 A1 (France, 04/1991), DE 4112360 A1, “Chatmac—Sled Dog Supplier,” and “Sled Dog Central.”

None of the above patents and publications, taken either singularly or in combination, is seen to describe the instant invention as claimed.

### SUMMARY OF THE INVENTION

The present invention is directed to an animal-powered vehicle. In one embodiment the vehicle includes a handle bar, first and second substantially vertically aligned wheel holders, first and second wheels, first and second elongated, platform support pillars, a platform, a substantially rigid, elongated steering stem, and a brake system. The vehicle also includes a means for supporting the platform, and an optional means for load-balance steering. The wheel holders are respectively attached proximate to the ends of the handle bar. The top ends of the platform support pillars are respectively attached proximate to the ends of the handle bar such that the platform support pillars respectively extend downward proximate to and inside the wheel holders. The steering stem extends forward with respect to the middle portion of the handle bar. The brake system is optionally configured to provide skid-steer steering capability.

### BRIEF DESCRIPTION OF THE DRAWINGS

FIG. 1 shows an environmental view of an animal-powered vehicle according to the present invention.

FIG. 2 shows a perspective view of the animal-powered vehicle of FIG. 1.

FIG. 3 shows a rear view of the animal-powered vehicle of FIG. 1.

FIG. 3A shows a rear view of an animal-powered vehicle according to the present invention.

FIG. 3B shows a rear view of an animal-powered vehicle according to the present invention.

FIG. 4 shows a bottom view of the animal-powered vehicle of FIG. 1.

FIG. 5 shows a perspective view of an animal-powered vehicle according to a further embodiment of the invention.

FIG. 6 shows a perspective view of the animal-powered vehicle according to a still further embodiment of the present invention.

FIG. 7 shows a perspective view of the animal-powered vehicle of FIG. 1.

FIG. 8 shows an exploded view of the animal-powered vehicle of FIG. 1.

Similar reference characters denote corresponding features consistently throughout the attached drawings.

### DETAILED DESCRIPTION OF THE PREFERRED EMBODIMENTS

The present invention is directed to a dog chariot powered by one or more dogs. Still more specifically, the invention is a dog powered chariot that can be used conventionally to transport at least one human operator or as a sport or recreational vehicle.

Referring to the present disclosure in general, the animal-powered vehicle of the invention is denoted generically by the reference numeral 100 as a whole, and specific embodiments are denoted by alphanumeric labels such as 100a, 100b, etc.

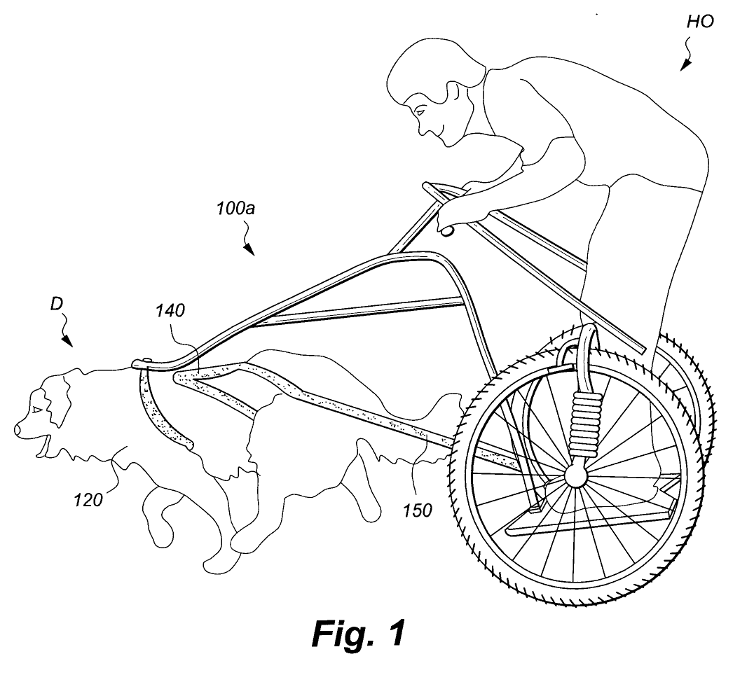

FIG. 1 shows an environmental view of an animal-powered vehicle 100 (actually represented in FIG. 1 by the alpha-numeric label “100a”) according to the present invention. The animal-powered vehicle 100a is shown in combination with a human operator HO and at least one animal (represented in FIG. 1 by at least one dog D). It should be understood that any suitable animal may be used to drive the animal-powered vehicle 100a such as, but not limited to, small or miniature horse breeds such as a Shetland pony. The at least one dog D is shown attached to the vehicle 100a by an animal steering harness 120 and an animal drive harness 140; the animal drive harness includes strap 150.

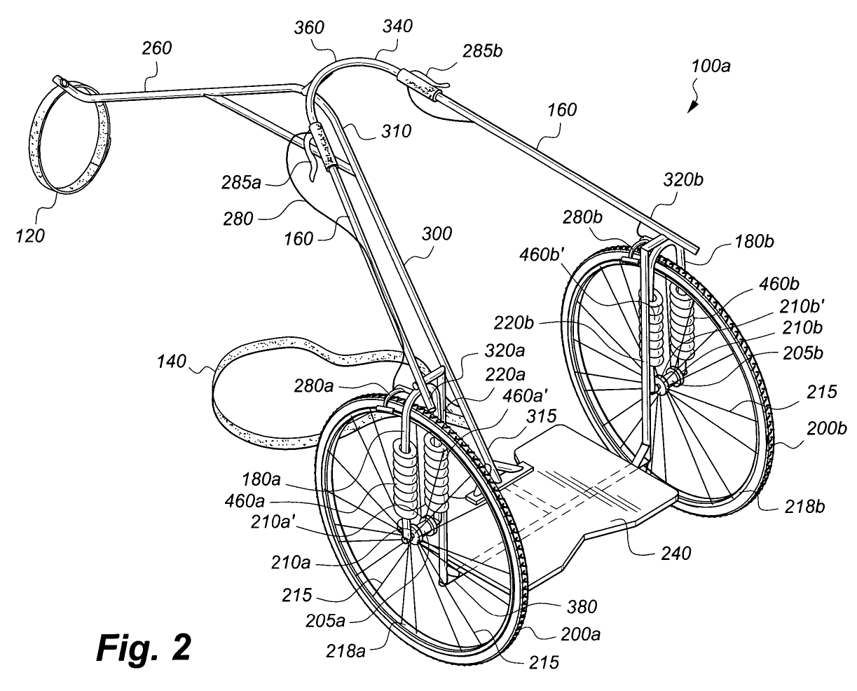

Referring to FIG. 2, which shows a perspective view of the animal-powered vehicle 100a of FIG. 1, the animal-powered vehicle 100a includes a handle bar 160, first 180a and second 180b substantially vertically aligned wheel holders, first 200a and second 200b wheels, first 220a and second 220b elongated platform support pillars, a platform 240, a substantially rigid and elongated steering stem 260, and a brake system 280. The animal-powered vehicle 100a optionally includes a handle bar support stem 300, steering harness 120, and drive harness 140. The handle bar support stem 300 has top and bottom ends 310 and 315, respectively. The drive harness 140 is shown attached proximate to the bottom end 315 of handle bar support stem 300. The brake system 280 comprises brake calipers 280a and 280b and brake levers 285a and 285b. The wheel holders 180a and 180b in combination with wheels 200a and 200b provide the means for supporting the animal-powered vehicle 100a above the ground.

During normal use of the device 100a, the platform 240 is preferably close to the ground with a clearance height of about 2″ to about 16″ and more preferably between about 4″ and 10″, and still more preferably between about 5″ and about 8″. When the device 100a is fitted with 26″ wheels fitted with typical mountain tires, the platform is preferably about 7″ above the ground, i.e. has about 7″ of ground clearance; a ground clearance of about 7″ provides adequate stability when an average sized adult stands on the platform 240.

The platform 240 can be at any suitable distance below the centers of the wheels 200a and 200b; for example, if the wheels 200a and 200b are 26″ bicycle wheels with wheel centers in the form of hub bodies 205a and 205b, the platform 240 can be about 6″ below the wheel hub bodies 205a and 205b. It should therefore be understood that the platform 240 can be any suitable height above the ground, but that the animal-powered vehicle 100a is more stable when the platform 240 is slung close enough to the ground to promote vehicle stability but with sufficient clearance to avoid frequent damage to the underside of the platform 240.

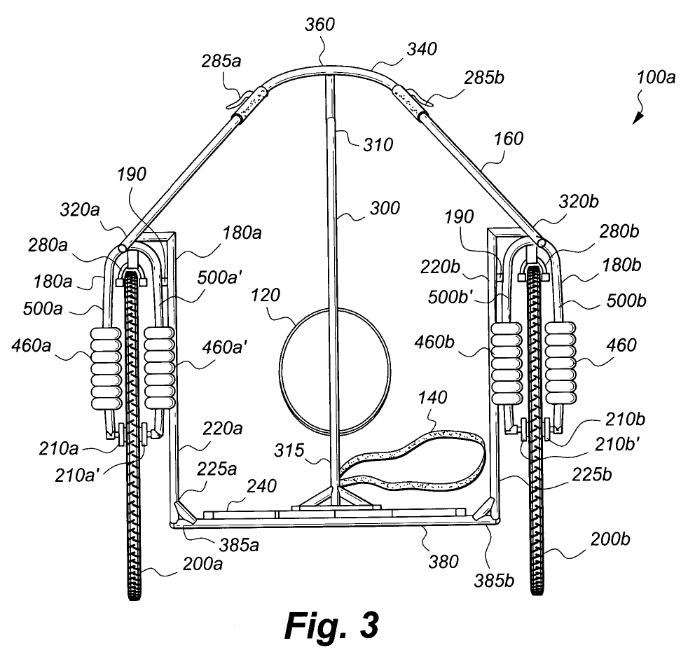

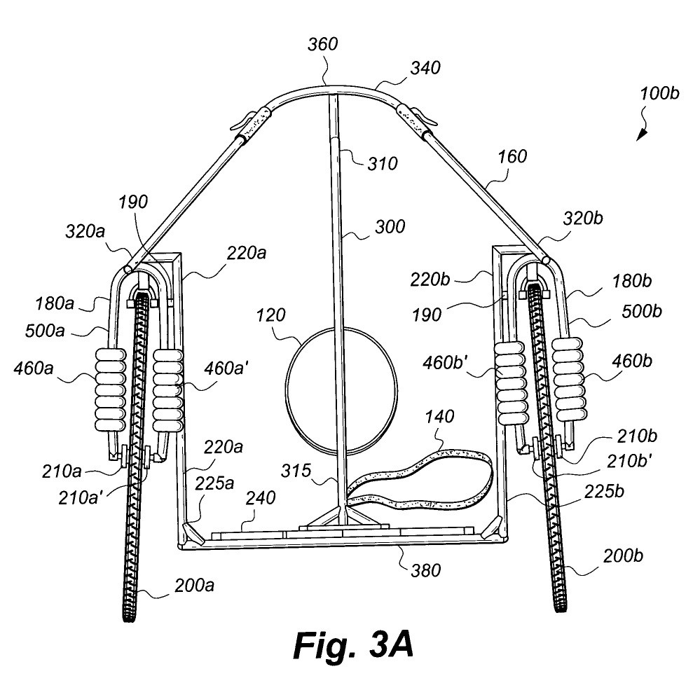

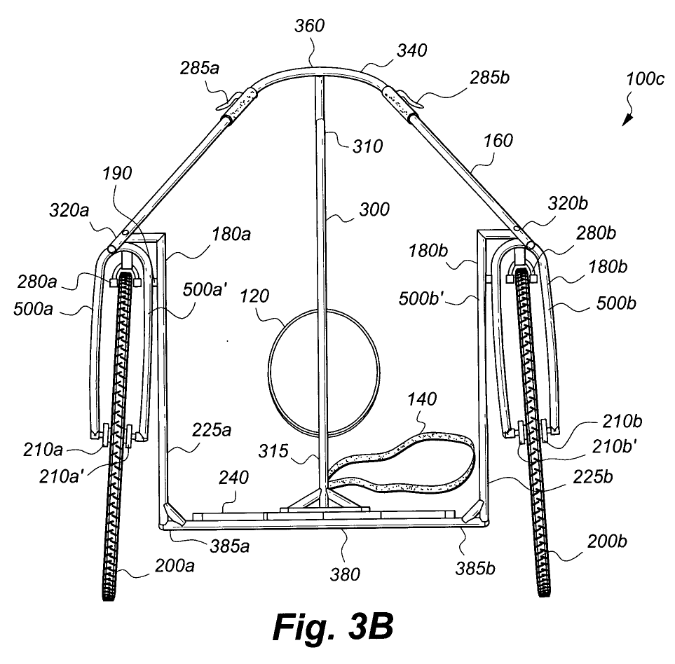

Referring to FIGS. 2 and 3, the animal-powered vehicle 100a comprises an optional means for load-balance steering, wherein the means for load-balance steering comprises suspension members 460a and 460a′ which are incorporated respectively into fork stems 500a and 500a′ (labeled in FIG. 3), and suspension members 460b and 460b′ which are incorporated respectively into fork stems 500b and 500b′ (labeled in FIG. 3). It would be understood by a person of ordinary skill in the art that any suitable suspension system could be used, i.e., the location, type, and number of suspension members might vary.

The suspension members serve to provide a load-balance steering capability to the device 100. Specifically, the human operator HO can steer the device 100 by placing more of his/her weight near one of the wheels 200a or 200b. For example, if the human operator HO places his/her weight closer to wheel 200a while the device 100 is in motion, this causes the device to turn to the left, the effect being magnified and transmitted along the steering stem 260 which moves to the left thus signaling to the at least one dog D to go left. Alternatively, if the human operator HO places his/her weight closer to wheel 200b while the device 100 is in motion, this causes the device to turn to the right, the effect being magnified and transmitted along the steering stem 260 to the at least one dog D. The at least one dog D is taught to respond to the sideways pull of the steering stem 260; if there is no sideways pull the at least one dog D simply travels in a straight line.

The brake system 280, which comprises brake calipers 280a and 280b and brake levers 285a and 285b, provides skid-steer steer capability in much the same way as a tracked vehicle or skid-steer loader is steered. Specifically, brake pressure can be applied to brake calipers member 280a or 280b to adjust independently the speed of one of the wheels 200a and 200b, respectively. Adjusting the speed or turn rate of one wheel compared to the other creates a torque on the device 100 and causes it to pivot around the slower wheel. When equal braking power is applied to both brake calipers 282a and 282b the device 100 brakes in a straight line.

It should be understood that the brake system 280 can take any suitable form so long as the system can bring the device 100 to a stop. Specifically, while it is preferred that the brake system 280 can provide brake steering capability, the brake system 280 does not exclude a limited brake system that is limited to providing simultaneous and substantially equal braking power to both wheels 200a and 200b. In addition, the brake system 280 can be disposed in any suitable manner around the animal-powered vehicle 100.

With regard to the FIGURES in general, the wheel holders 180a and 180b take the form of bicycle forks. More specifically, the wheel holder 180a includes inner and outer fork stems 500a and 500a′, respectively; and wheel holder 180b includes inner and outer fork stems 500b and 500b′, respectively. However, it should be understood that the wheel holders can take any suitable form and are expressly not limited to bicycle forks.

Still referring to FIG. 2, the centers of the first 200a and second 200b wheels respectively include first 205a and second 205b hub bodies and flange pairs 210a, 210a′ and 210b, 210b′ to which spokes 215 are attached and spread out to the rims 218a and 218b of wheels 200a and 200b, respectively. Handle bar 160 has first 320a and second 320b ends, and a middle portion 340 defined therebetween. As an example, but not limited to the example, the handle bar 160 has a curved shape and the middle portion 340 has an apex 360. It is obvious to one of ordinary skill in the art that the handle bar 160 may adopt any suitable shape. The handle bar 160 allows a human operator to grasp or hold onto the animal-powered vehicle 100a to maintain stability while the vehicle 100a is in operation.

FIG. 3 shows a rear view of the animal-powered vehicle 100a of FIG. 1. Wheel 200a and 200b are substantially aligned in parallel with respect to each other and sit vertically upright with respect to the ground during normal operation of the vehicle 10a. Spacers 190 fit between wheel holders 180a/180b and pillars 220a/220b. The spacers 190 are optionally adjustable spacers.

It should be understood that any suitable form of wheel can be used in the present invention; non-limiting examples of wheels include mountain bike wheels, hybrid bicycle wheels (cross between tougher mountain bike wheels and bicycle racing wheels), BMX wheels, Mag wheels (such as those supplied by NYCEwheels Inc. of New York, N.Y. 10028), moped wheels, or motorcycle wheels or heavier horse cart wheels, though it is preferred that the wheels are relatively lightweight the exact form of wheels can vary without detracting from the spirit of the present invention.

FIG. 3A shows a rear view of an animal-powered vehicle 100b according to a further embodiment of the invention in which the wheels 200a and 200b (and wheel holders 180a and 180b) are inclined slightly inwards. Specifically, the camber or bottom of each wheel is slightly offset with respect to the top of each wheel. The offset is about 0.5″ to about 4″, and preferably about 0.5″ to about 1.5″, and more preferably about 0.5″ to about 0.75″. The offset helps deal with the asymmetrical distribution of load as a result of the wheel holder/support pillar combination.

FIG. 3B shows a rear view of the animal-powered vehicle 100 (actually represented in FIG. 3B by the alpha-numeric label “100c”) in which the vehicle lacks suspension members 460a, 460a′, 460b, and 460b′.

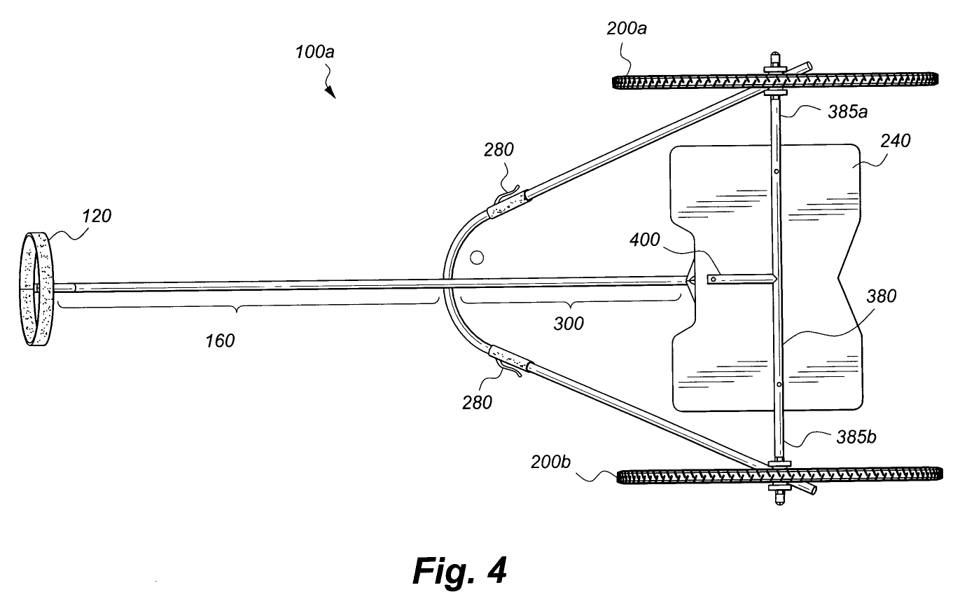

FIG. 4 shows a bottom view of the animal-powered vehicle 100a of FIG. 1. The layout of the underside of the platform 240 is visible. A main platform support arm 380 supports the platform 240 in combination with a short platform support arm 400 attached at about a perpendicular angle and proximate to the midpoint of the main platform support arm 380. The first and second opposite ends 385a and 385b of the main platform support arm 380 are respectively attached respectively to the bottom ends 225a and 225b of platform support pillar 220a and 220b as shown in FIGS. 3 and 3A. The pillars 220a and 220b, and support arms 380 and 400 provide a non-limiting means for holding the platform 240 to the animal-powered vehicle 100.

Many of the components of the animal-powered vehicle 100 can be made out of tubular steel such as the handle bar 160, pillars 220a and 220b, handle bar support stem 300, main platform support arm 380, and short platform support arm 400. The handle bar 160 can also be made of box steel such as, but not limited to, 1″ box steel.

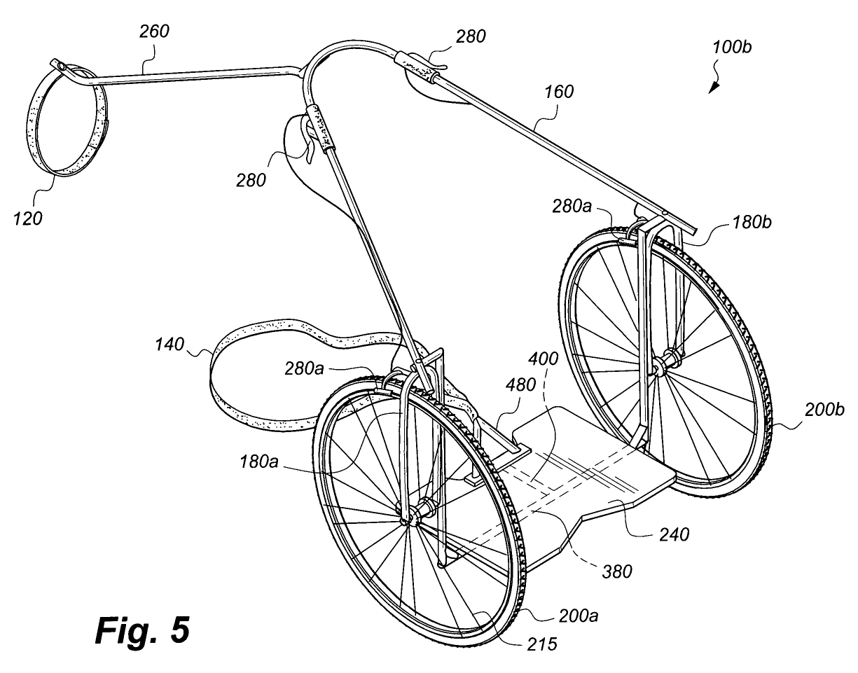

FIG. 5 shows a perspective view of an animal-powered vehicle 100d according to a further embodiment of the invention in which at least one drive harness attachment member 480 replaces the optional handle bar support stem 300. The at least one drive harness 140 is attached to the at least one drive harness attachment member 480.

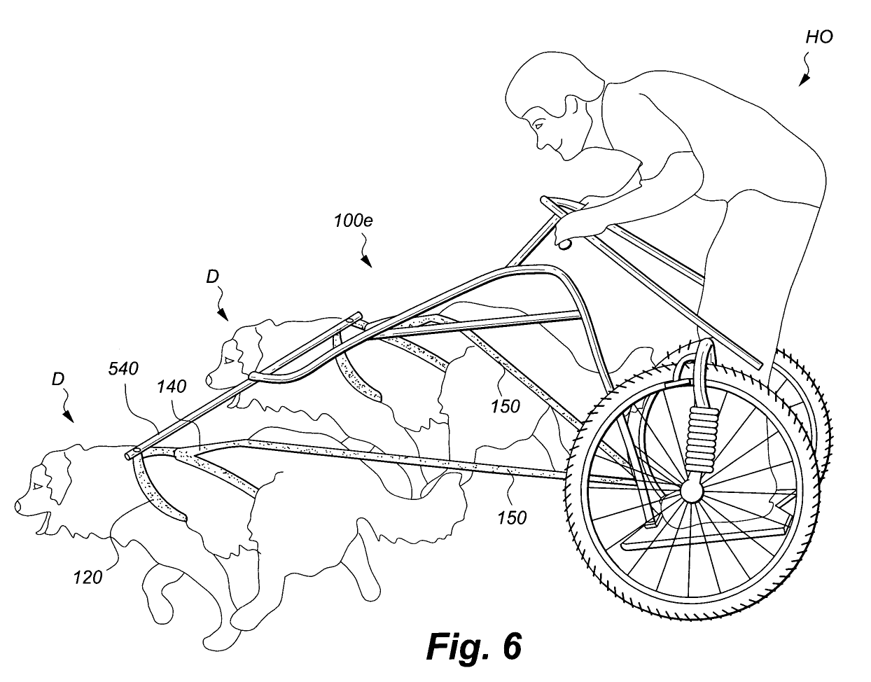

FIG. 6 shows a perspective view of an animal-powered vehicle 100e, which comprises a means in the form of cross bar 540 for attaching more than one animal to the apparatus 100e. Two dogs are shown each fitted with a steering harness 120 and a drive harness 140. Each steering harness 120 is attached to opposite half's of the cross bar 540, and both drive harnesses 140 are respectively attached to opposite half's of the modified drive harness attachment member 480a.

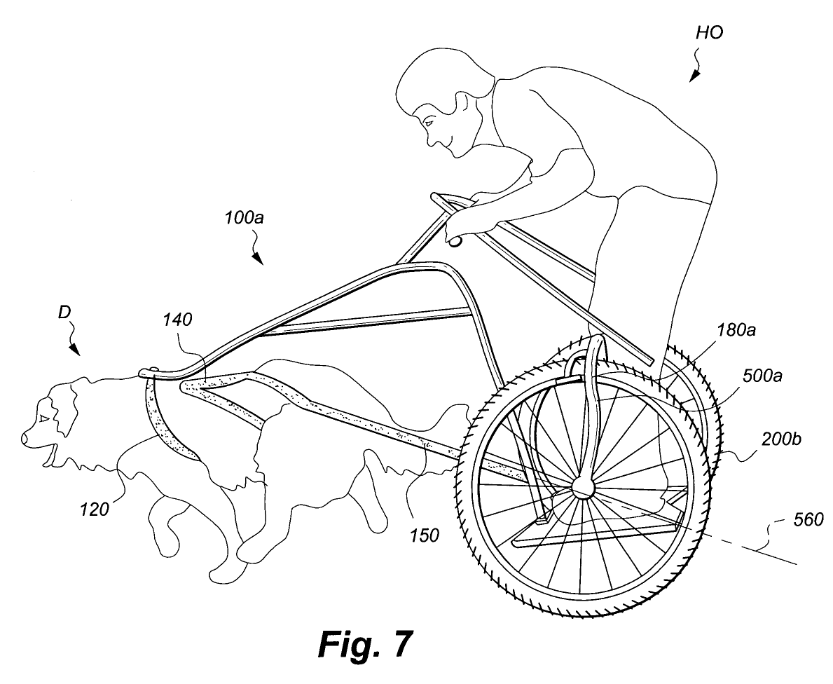

FIG. 7 shows the animal-powered vehicle 100a of FIG. 1, wherein the at least one animal drive harness 140 includes a straps 150 that point rearward at a downward angle generating a virtual line 560 in the same plane as the center of the wheels 200a and 200b defined, for example, by the bottom portions of the outer stems 500a and 500b (stem 500b is not visible in FIG. 7 but is shown, for example, in FIG. 3).

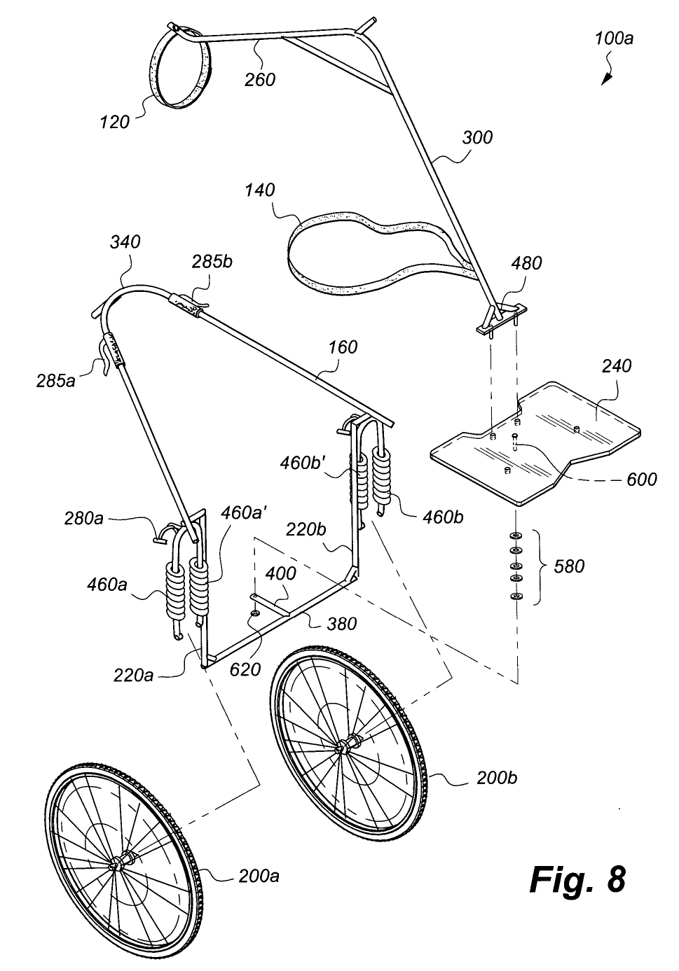

FIG. 8 shows an exploded view of the animal-powered vehicle 100a according to the invention. Optional spacers 580 fit around a bolt 600 connecting the short platform support arm 400 to the underside of the platform member 240. Different thickness spacers enable alter the horizontal slant of the platform 240 to enable fine-tuning of the animal-powered vehicle 100. For example, a large flat spacer (more than ⅜ths of an inch in thickness) will cause the platform to tilt back thereby causing the human operator HO to move forward and, for example, a large dog to be attached to the vehicle 100.

It is to be understood that the present invention is not limited to the embodiments described above, but encompasses any and all embodiments within the scope of the following claims.

What is claimed is:

1. An animal-powered vehicle comprising:
a handle bar having first and second ends and a middle portion defined therebetween;
first and second substantially vertically aligned wheel holders, wherein said wheel holders are respectively attached proximate to said first and second ends of said handle bar;
first and second wheels, wherein said wheels are respectively secured to said wheel holders and are normally in contact with the ground during normal operation of said animal-powered vehicle, and wherein said wheel holders and said wheels are aligned in the normal direction of movement of said animal-powered vehicle;
a platform;
means for holding said platform to said animal-powered vehicle;
a substantially rigid, elongated steering stem having proximal and distal ends, wherein said proximal end of said steering stem is attached to said animal-powered vehicle proximate to said middle portion of said handle bar, wherein said steering stem extends forwardly with respect to said middle portion of said handle bar; and
a brake system disposed about said animal-powered vehicle and in communication with said wheels, wherein said brake system is adapted for braking each wheel independently upon a braking command from the operator, and wherein said brake system gives the operator the capability to steer said animal-powered vehicle in a skid-steer fashion.

2. The animal-powered vehicle of claim 1, further comprises a means for load-balance steering.

3. The animal-powered vehicle of claim 1, wherein said first and second wheel holders respectively comprise first and second wheel forks, wherein each of said wheel forks comprises inner and outer fork stems.

4. The animal-powered vehicle of claim 1, wherein said bottom ends of said platform support pillars terminate at a point above the ground but inward and beyond said bottom ends of said wheel holders.

5. The animal-powered vehicle of claim 1, wherein said platform is suspended at a predetermined height above the ground between said wheels.

6. The animal-powered vehicle of claim 1, wherein, during normal operation of said vehicle, said steering stem extends forwardly at a downward angle with respect to the ground.

7. The animal-powered vehicle of claim 1, wherein said brake system comprises first and second independent brakes respectively in communication with said wheels.

8. The animal-powered vehicle of claim 1, further comprising:
at least one animal steering harness,
at least one animal drive harness,
at least one drive harness attachment member,
wherein said at least one animal steering harness is attached to said steering stem, and said at least one animal drive harness is attached to said at least one drive harness attachment member.

9. The animal-powered vehicle of claim 8, wherein said at least one animal drive harness points rearward at a downward angle generating a virtual line in the same plane as the center of said wheels.

10. The animal-powered vehicle of claim 1, further comprising:
a handle bar support stem having top and bottom ends, wherein said top and bottom ends of said handle bar support stem are respectively attached proximate to said middle portion of said handle bar and to said platform,
wherein said proximal end of said steering stem is attached to said animal-powered vehicle proximate to said middle portion of said handle bar and proximate to said top end of said handle bar support stem, and wherein said steering stem extends forwardly with respect to said middle portion of said handle bar and said top end of said handle bar support stem.

11. The animal-powered vehicle of claim 10, further comprising:
at least one animal steering harness,
at least one animal drive harness,
wherein said at least one animal steering harness is attached to said steering stem, and said at least one animal drive harness is attached to said handle bar support stem.

12. The animal-powered vehicle of claim 8, wherein said at least one animal drive harness points rearward at a downward angle generating a virtual line in the same plane as the center of said first and second wheels.

13. The animal-powered vehicle of claim 1, further comprises a means for varying the tilt of said platform.

14. An animal-powered vehicle comprising:
a handle bar having first and second ends and a middle portion defined therebetween;
first and second substantially vertically aligned wheel holders, wherein said wheel holders are respectively attached proximate to said first and second ends of said handle bar;
first and second wheels, wherein said wheels are respectively secured to said wheel holders and are normally in contact with the ground during normal operation of said animal-powered vehicle, and wherein said wheel holders and said wheels are aligned in the normal direction of movement of said animal-powered vehicle;
first and second elongated, platform support pillars, wherein each of said platform support pillars has opposite top and bottom ends, and wherein said top ends of said platform support pillars are respectively attached proximate to said first and second ends of said handle bar such that said platform support pillars respectively extend downwardly proximate to and inside said wheel holders;
a platform support arm having first and second opposite ends, wherein said ends of said platform support arm are respectively attached to said bottom ends of said platform support pillars;
a platform, wherein said platform has a front end, a rear end, and first and second sides, and wherein said platform is supported by at least said platform support arm and positioned between said platform support pillars;
a handle bar support stem having top and bottom ends, wherein said top and bottom ends of said handle bar support stem are respectively attached to said middle portion of said handle bar and to said platform;
a substantially rigid, elongated steering stem having proximal and distal ends, wherein said proximal end of said steering stem is attached to said animal-powered vehicle proximate to said middle portion of said handle bar and proximate to said top end of said handle bar support stem, wherein said steering stem extends forwardly with respect to said middle portion of said handle bar and said top end of said handle bar support stem, and wherein said steering stem is adapted for attachment with animal steering harness; and
a brake system disposed about said animal-powered vehicle and in communication with said wheels, wherein said brake system is adapted for braking each wheel independently upon a braking command from the operator, and wherein said brake system gives the operator the capability to steer said animal-powered vehicle in a skid-steer fashion.

15. The animal-powered vehicle of claim 14, further comprising a means for load-balance steering.

16. The animal-powered vehicle of claim 14, wherein said bottom ends of said platform support pillars terminate at a point above the ground but inward and beyond said bottom ends of said wheel holders, and wherein said platform is a low slung platform suspended at a predetermined height above the ground between said wheels.

17. The animal-powered vehicle of claim 14, wherein said platform is suspended at a predetermined height above the ground between said wheels.

18. The animal-powered vehicle of claim 14, further comprising:
means for attaching at least one animal to said animal-powered vehicle, said means comprising at least one animal steering harness attached to said steering stem and at least one animal drive harness attached to a drive harness attachment member;
wherein said first and second wheel holders respectively are first and second wheel forks, and wherein each of said wheel forks comprises inner and outer fork stems,
wherein said first and second wheels respectively comprise a first hub body and a second hub body, and wherein said at least one animal drive harness points rearward at a downward angle whereby said at least one animal drive intercepts a virtual line between the centers of said first and second wheels,
wherein, during normal operation of said animal-powered vehicle, said steering stem extends forwardly at a downward angle with respect to the ground, and
wherein said brake system comprises first and second independent brakes respectively in communication with said wheels.

19. An animal-powered vehicle comprising:
a handle bar having first and second ends and a middle portion defined therebetween;
means for supporting the animal-powered vehicle above the ground;
means for load-balance steering;
a platform and means to support said platform at a predetermined height above the ground;
a handle bar support stem having top and bottom ends, wherein said top and bottom ends of said handle bar support stem are respectively attached to said middle portion of said handle bar and to said platform;
a substantially rigid, elongated steering stem having proximal and distal opposite ends, wherein said proximal end of said steering stem is attached to said animal-powered vehicle proximate to said middle portion of said handle bar and proximate to said top end of said handle bar support stem, wherein said steering stem extends forwardly with respect to said middle portion of said handle bar and said top end of said handle bar support stem, and wherein, during normal operation of said animal-powered vehicle, said steering stem extends forwardly at a downward angle with respect to the ground;
a means for braking said animal-powered vehicle, wherein said means for braking gives an operator the capability to steer said animal-powered vehicle in a skid-steer fashion;
at least one direction responsive animal harness attached proximate to said distal end of said steering stem; and
at least one animal drive harness attached proximate to said bottom end of said handle bar support stem.

20. The animal-powered vehicle of claim 19, further comprises a means for varying the tilt of said platform.
